(19) United States
(12) Patent Application Publication
(10) Pub. No.: US 2026/0074740 A1
(43) Pub. Date: Mar. 12, 2026

(54) METHOD AND DEVICE FOR ALLOCATING PAYLOAD USING UWB COMMUNICATION

(71) Applicant: Samsung Electronics Co., Ltd., Gyeonggi-do (KR)

(72) Inventors: Jinwook SEO, Gyeonggi-do (KR); Joohyun LEE, Gyeonggi-do (KR); Junyoung CHOI, Gyeonggi-do (KR)

(21) Appl. No.: 19/321,926

(22) Filed: Sep. 8, 2025

(30) Foreign Application Priority Data
Sep. 6, 2024 (KR) 10-2024-0121739

(51) Int. Cl. H04B 1/7163; G01S 13/02; G01S 13/76; H04L 69/22

(52) U.S. Cl. CPC H04B 1/7163; G01S 13/0209; G01S 13/765; H04L 69/22; H04B 2201/71634

(57) ABSTRACT

A method of a first ultra-wideband (UWB) device according to an embodiment of the disclosure may comprise transmitting a control message including a ranging device management list (RDML) for UWB ranging; transmitting a ranging initiation message based on the control message; and receiving, from a second UWB device, a ranging response message corresponding to the ranging initiation message and data piggybacked on the ranging response message, wherein the data includes a header and a payload, and wherein the header includes a length of the data and an address of the second UWB device.

### CROSS-REFERENCE TO RELATED APPLICATION(S)

This application is based on and claims priority under 35 U.S.C. § 119 to Korean Patent Application No. 10-2024-0121739, which was filed in the Korean Intellectual Property Office on Sep. 6, 2024, the entire disclosure of which is incorporated herein by reference.

### BACKGROUND

### 1. Field

The disclosure relates generally to ultra-wideband (UWB) communication and, more particularly, to a payload allocation method and device using UWB communication.

### 2. Description of Related Art

The Internet is evolving from the human-centered connection network by which humans create and consume information to the Internet of things (IoTs) network by which information is communicated and processed between things or other distributed components. Another arising technology is the Internet of everything (IoE) network, which is a combination of big data processing technology and the IoT technology through, e.g., a connection with a cloud server. Implementing the IoT requires technical elements, such as sensing technology, a wired/wireless communication and network infrastructure, service interface and security technologies. Recent ongoing research for thing-to-thing connections relates to techniques for sensor networking, machine-to-machine (M2M) communication, or machine-type communication (MTC).

The IoT environment may offer intelligent Internet technology (IT) services that collect and analyze the data generated by the things connected with one another to create a new value for human life. The IoT technology may have various applications, such as smart home applications, smart building applications, smart city applications, smart car or connected car applications, smart grid applications, health-care applications, smart appliance industry applications, or state-of-art medical services applications, through conversion or integration of conventional IT techniques and various industries.

As wireless communication systems evolve to provide various services, a need arises for a method for effectively providing such services. For example, it is possible to use a ranging technique for measuring the distance between electronic devices using UWB. UWB is a wireless communication technology that uses a very wide frequency band of several gigahertz (GHz) or more in a baseband without using a wireless carrier.

### SUMMARY

The disclosure has been made to address the above-mentioned problems and disadvantages, and to provide at least the advantages described below.

According to an embodiment, a method of a first UWB device in a wireless communication system includes transmitting a control message including a ranging device management list (RDML) for UWB ranging; transmitting a ranging initiation message based on the control message; and receiving, from a second UWB device, a ranging response message corresponding to the ranging initiation message and data piggybacked on the ranging response message, wherein the data includes a header and a payload, and wherein the header includes a length of the data and an address of the second UWB device.

According to another embodiment, a method of a second UWB device in a wireless communication system includes receiving, from a first UWB device, a control message including an RDML for UWB ranging; receiving, from the first UWB device, a ranging initiation message based on the control message; and transmitting, to the first UWB device, a ranging response message corresponding to the ranging initiation message and data piggybacked on the ranging response message, wherein the data includes a header and a payload, and wherein the header includes a length of the data and an address of the second UWB device.

According to another embodiment, a first UWB device in a wireless communication system includes a transceiver; and a processor coupled with the transceiver and configured to control to transmit a control message including an RDML for UWB ranging; control to transmit a ranging initiation message based on the control message; and receive, from a second UWB device, a ranging response message corresponding to the ranging initiation message and data piggybacked on the ranging response message, wherein the data includes a header and a payload, and wherein the header includes a length of the data and an address of the second UWB device.

According to another embodiment, a second UWB device in a wireless communication system includes a transceiver; and a processor coupled with the transceiver and configured to receive, from a first UWB device, a control message including an RDML for UWB ranging; receive, from the first UWB device, a ranging initiation message based on the control message; and control to transmit, to the first UWB device, a ranging response message corresponding to the ranging initiation message and data piggybacked on the ranging response message, wherein the data includes a header and a payload, and wherein the header includes a length of the data and an address of the second UWB device.

### DESCRIPTION OF THE DRAWINGS

The above and other aspects, features, and advantages of certain embodiments of the disclosure will be more apparent from the following description taken in conjunction with the accompanying drawings, in which:

FIG. 1 is an example architecture of a UWB device, according to an embodiment;

FIG. 2 is an example configuration of a communication system including a UWB device, according to an embodiment;

FIG. 3 is a structure of a ranging block and a round used for UWB ranging, according to an embodiment;

FIG. 4 is a method for performing UWB communication by two UWB devices, according to an embodiment;

FIGS. 5A and 5B are methods for performing UWB ranging by two UWB devices, according to an embodiment;

FIG. 6 is an example of one-to-one (1:1) double-sided (DS)-two-way ranging (TWR) ranging, according to an embodiment;

FIG. 7 is an example of one-to-many (1:N) DS-TWR ranging, according to an embodiment;

FIG. 8 is an example of transmitting a data message by a UWB device in a gate system, according to an embodiment;

FIG. 9 is a view illustrating examples of payloads in a data message, according to an embodiment;

FIG. 10 is a view illustrating examples of headers included in a data message, according to an embodiment;

FIG. 11A is an example of a method for determining the number of responders by a UWB device, according to an embodiment;

FIG. 11B is an example of a payload information element (IE) content field of a control message, according to an embodiment;

FIG. 11C is an example of an RDML used during a DS-TWR, according to an embodiment;

FIG. 12 is an example of a method for determining whether to transmit data or segmented data by a UWB device, according to an embodiment;

FIG. 13 is an example of a method for configuring a phase in a ranging block in a gate system, according to an embodiment;

FIG. 14 is a view illustrating examples of headers included in a data message, according to an embodiment;

FIG. 15 is a view illustrating examples of headers included in a data message, according to an embodiment;

FIG. 16 is an example of a method for configuring a phase in a ranging block in a gate system, according to an embodiment;

FIG. 17 is a structure of a first UWB device, according to an embodiment; and

FIG. 18 is a structure of a second UWB device, according to an embodiment.

### DETAILED DESCRIPTION

Hereinafter, embodiments of the disclosure are described in detail with reference to the accompanying drawings.

In describing embodiments, the description of technologies that are known in the art and are not directly related to the disclosure is omitted. This is for further clarifying the features of the disclosure without adding uncertainty.

For the same reasons, some elements may be exaggerated or schematically shown. The size of each element does not necessarily reflect the real size of the element. The same reference numeral is used to refer to the same element throughout the drawings.

Advantages and features of the disclosure, and methods for achieving the same may be understood through the embodiments to be described below taken in conjunction with the accompanying drawings. However, the disclosure is not limited to the embodiments disclosed herein, and various changes may be made thereto. The embodiments disclosed herein are provided only to inform one of ordinary skill in the art of the category of the disclosure. The disclosure is defined by the appended claims. The same reference numeral denotes the same element throughout the specification.

The blocks in each flowchart and combinations of the flowcharts may be performed by computer program instructions. Since the computer program instructions may be equipped in a processor of a general-use computer, a special-use computer or other programmable data processing devices, the instructions executed through a processor of a computer or other programmable data processing devices generate means for performing the functions described in connection with a block(s) of each flowchart. Since the computer program instructions may be stored in a computer-available or computer-readable memory that may be oriented to a computer or other programmable data processing devices to implement a function in a specified manner, the instructions stored in the computer-available or computer-readable memory may produce a product including an instruction means for performing the functions described in connection with a block(s) in each flowchart. Since the computer program instructions may be equipped in a computer or other programmable data processing devices, instructions that generate a process executed by a computer as a series of operational steps are performed over the computer or other programmable data processing devices and operate the computer or other programmable data processing devices may provide steps for executing the functions described in connection with a block(s) in each flowchart.

Further, each block may represent a module, segment, or part of a code including one or more executable instructions for executing a specified logical function(s). Further, it should also be noted that in some embodiments, the functions mentioned in the blocks may occur in different orders. For example, two blocks that are consecutively shown may be performed substantially simultaneously or in a reverse order depending on corresponding functions.

As used herein, the term “unit” means a software element or a hardware element such as a field-programmable gate array (FPGA) or an application specific integrated circuit (ASIC). A unit performs a defined role. However, “unit” is not limited to software or hardware. A “unit” may be configured in a storage medium that may be addressed or may be configured to execute one or more processors. Accordingly, as an example, a “unit” includes elements, such as software elements, object-oriented software elements, class elements, and task elements, processes, functions, attributes, procedures, subroutines, segments of program codes, drivers, firmware, microcode(s), circuits, data, databases, data architectures, tables, arrays, and variables. Functions provided within the components and the “units” may be combined into smaller numbers of components and “units” or further separated into additional components and “units”. Further, the components and “units” may be implemented to execute one or more central processing units (CPUs) in a device or secure multimedia card. According to embodiments of the disclosure, a “ . . . unit” may include one or more processors.

As used herein, the term “terminal” or “device” may also be referred to as a mobile station (MS), user equipment (UE), user terminal (UT), terminal, wireless terminal, access terminal (AT), subscriber unit, subscriber station (SS), wireless device, wireless communication device, wireless transmit/receive unit (WTRU), mobile node, or mobile or may be referred to in other terms. Various embodiments of the terminal may include cellular phones, smart phones with wireless communication capabilities, personal digital assistants (PDAs) with wireless communication capabilities, wireless modems, portable computers with wireless communication capabilities, capturing/recording/shooting/filming devices, such as digital cameras, having wireless communication capabilities, game players with wireless communications capabilities, music storage and playback home appliances with wireless communications capabilities, Internet home appliances capable of wireless Internet access and browsing, or portable units or terminals incorporating combinations of those capabilities. Further, the terminal may include a an M2M terminal and an MTC terminal/device, but is not limited thereto. In the disclosure, the terminal may be referred to as an electronic device or simply as a device.

Hereinafter, various embodiments of the disclosure are described below with reference to the accompanying drawings. When the subject matter of the disclosure may become unclear, the detailed description of known functions or configurations may be skipped in describing embodiments of the disclosure. The terms as used herein are defined considering the functions in the disclosure and may be replaced with other terms according to the intention or practice of the user or operator. Therefore, the terms should be defined based on the overall disclosure.

In accordance with an embodiment of the disclosure a payload allocation method is provided for exchanging data messages between a plurality of UWB devices in a UWB-based system.

A method and device according to an embodiment of the disclosure may prevent data loss by transmitting data messages in consideration of the transmission/reception capabilities of each device when exchanging data messages between a plurality of UWB devices.

Although a communication system using UWB is described in connection with embodiments of the disclosure, as an example, embodiments of the disclosure may also apply to other communication systems with similar technical background or features. For example, a communication system using Bluetooth™ or ZigBee™ may be included therein. Further, embodiments of the disclosure may be modified in such a range as not to significantly depart from the scope of the disclosure under the determination by one of ordinary skill in the art and such modifications may be applicable to other communication systems.

When the subject matter of the disclosure may become unclear, the detailed description of the known art or functions may be skipped. The terms as used herein are defined by considering the functions in the disclosure and may be replaced with other terms according to the intention or practice of the user or operator. Therefore, the terms should be defined based on the overall disclosure.

In general, wireless sensor network technology is largely divided into a wireless local area network (WLAN) technology and a wireless personal area network (WPAN) technology according to the recognition distance. In this case, WLAN is a technology based on the Institute of Electrical and Electronics Engineers (IEEE) 802.11 which enables access to the backbone network within a radius of about 100 meters (m). WPAN is a technology based on IEEE 802.15 which includes Bluetooth™, ZigBee™, and UWB. A wireless network in which such a wireless network technology is implemented may include a plurality of electronic devices.

UWB may refer to a short-range high-rate wireless communication technology using a wide frequency band of several GHz or more, low spectral density, and short pulse width (e.g., 1 nanoseconds (nsec) to 4 nsec) in a baseband state. UWB may mean a band to which UWB communication is applied. UWB may enable secure and accurate ranging between devices. Thus, UWB enables relative position estimation based on the distance between two devices or accurate position estimation of a device based on the distance from fixed devices (whose positions are known).

The terminology used herein is provided for a better understanding of the disclosure, and changes may be made thereto without departing from the technical spirit of the disclosure.

“Application dedicated file” (ADF) may be, e.g., a data structure in an application data structure that may host an application or application specific data.

“Application protocol data unit” (APDU) may be a command and a response used when communicating with the application data structure in the UWB device.

“Application specific data” may be, e.g., a file structure having a root level and an application level including UWB controlee information and UWB session data required for a UWB session.

“Controller” may be a ranging device that defines and controls ranging control messages (RCMs) (or control messages).

“Controlee” may be a ranging device using a ranging parameter in the RCM (or control message) received from the controller.

Unlike “static scrambled timestamp sequence (STS),” “dynamic STS mode” may be an operation mode in which the STS is not repeated during a ranging session. In this mode, the STS may be managed by the ranging device, and the ranging session key that generates STS may be managed by a secure component.

“Applet” may be an applet executed on the secure component including UWB parameters and service data. In this disclosure, applet may be a fine ranging (FiRa) applet defined by FiRa.

“Ranging device” may be a device capable of performing UWB ranging. In the disclosure, the ranging device may be an enhanced ranging device (ERDEV) defined in IEEE 802.15.4z or a FiRa device defined by FiRa. The ranging device may be referred to as a UWB device.

“UWB-enabled Application” may be an application for UWB service. For example, the UWB-enabled application may be an application using a framework API for configuring an out-of-band (OOB) connector, a secure service, and/or a UWB service for a UWB session. In this disclosure, “UWB-enabled Application” may be abbreviated as an application or a UWB application. UWB-enabled application may be a FiRa-enabled application defined by FiRa.

“Framework” may be a component that provides access to profiles, individual-UWB configuration and/or notifications. “Framework” may be, e.g., a collection of logical software components including a profile manager, an OOB connector, a secure service, and/or a UWB service. In the disclosure, the framework may be a FiRa framework defined by FiRa.

“OOB connector” may be a software component for establishing an OOB connection (e.g., Bluetooth™ low energy (BLE) connection) between ranging devices. In the disclosure, the OOB connector may be a FiRa OOB connector defined by FiRa.

“Profile” may be a previously defined set of UWB and OOB configuration parameters. In the disclosure, profile may be a FiRa profile defined by FiRa.

“Profile manager” may be a software component that implements a profile available on the ranging device. In the disclosure, the profile manager may be a FiRa profile manager defined by FiRa.

“Service” may be an implementation of a use case that provides a service to an end-user.

“Smart ranging device” may be a ranging device that may implement an optional framework API. In the disclosure, the smart ranging device may be a FiRa smart device defined by FiRa.

“Global dedicated file” (GDF) may be a root level of application specific data including data required to establish a universal serial bus (USB) session.

“Framework API” may be an API used by a UWB-enabled application to communicate with the framework.

“Initiator” may be a ranging device that initiates a ranging exchange.

“Object identifier” (OID) may be an identifier of the ADF in the application data structure.

“OOB” may be data communication that does not use UWB as an underlying wireless technology.

“RDS” may be data (e.g., UWB session key, session ID, etc.) required to establish a UWB session when it is needed to protect confidentiality, authenticity and integrity.

“Responder” may be a ranging device that responds to the initiator in a ranging exchange.

“STS” may be a ciphered sequence for increasing the integrity and accuracy of ranging measurement timestamps. The STS may be generated from the ranging session key.

“Secure channel” may be a data channel that prevents overhearing and tampering.

“Secure component” may be an entity (e.g., secure element (SE) or trusted execution environment (TEE)) having a defined security level that interfaces with a UWB subsystem (UWBS) for the purpose of providing RDS to UWBS, e.g., when dynamic STS is used.

“SE” may be a tamper-resistant secure hardware component that may be used as a secure component in the ranging device.

“Secure ranging” may be ranging based on STS generated through a strong encryption operation.

“Secure service” may be a software component for interfacing with a secure component, such as an SE or TEE.

“Service applet” may be an applet on a secure component that handles service specific transactions.

“Service data” may be data defined by a service provider that needs to be transferred between two ranging devices to implement a service.

“Service provider” may be an entity that defines and provides hardware and software required to provide a specific service to an end-user.

“Static STS mode” may be an operation mode in which STS is repeated during a session, and does not need to be managed by the secure component.

“Secure UWB service (SUS) applet” may be an applet on the SE that communicates with the applet to retrieve data needed to enable secure UWB sessions with other ranging devices. The SUS applet may transfer corresponding data (information) to the UWBS.

“UWB service” may be a software component that provides access to the UWBS.

“UWB session” may be a period from when the controller and the controlee start communication through UWB until the communication stops. A UWB session may include ranging, data transfer, or both ranging and data transfer.

“UWB Session identification” (where “identification” is represented by “ID”) may be an ID (e.g., a 32-bit integer) that identifies the UWB Session, shared between the controller and the controller.

“UWB session key” may be a key used to protect the UWB session. The UWB session key may be used to generate the STS. In this disclosure, the UWB session key may be a UWB ranging session key (URSK), and may be abbreviated as a session key.

“UWB subsystem” (UWBS) may be a hardware component implementing the UWB physical layer (PHY) and medium access control (MAC) specifications. UWBS may have an interface to framework and an interface to secure component to search for RDS. In this disclosure, the UWB PHY and MAC specifications may be, e.g., FiRa PHY and FiRa MAC specifications defined by FiRa referring to IEEE 802.15.4/4z.

“UWB message” may be a message including a payload IE transmitted by the UWB device (e.g., endpoint ranging device (ERDEV)).

The “ranging message” may be a message transmitted by a UWB device (e.g., ERDEV) in a UWB ranging procedure. For example, the ranging message may be a message, such as a ranging initiation message (RIM), a ranging response message (RRM), a ranging final message (RFM), or a measurement report message (MRM), transmitted by a UWB device (e.g., ERDEV) in a specific phase of the ranging round. A ranging message may include one or more UWB messages. If necessary, a plurality of ranging messages may be merged into one message. For example, in the case of non-deferred DS-TWR ranging, RFM and MRM may be merged into one message in a ranging final phase.

“Payload IE” may be referred to as a payload IE and may be included in the MAC payload of the UWB MAC frame defined in the IEEE 802.15 standard. The MAC payload may include a plurality of payload IEs.

“Data transferIE” may be an additional payload IE for transmitting application data. Application data may be data transferred from a framework or application above the UWB MAC Layer. The data transfer IE may be used in the procedure for ranging between the initiator and the responder. In this case, the ranging message may include at least one or both of the payload IE for ranging and the data transfer IE for application data transfer. For example, the data transfer IE may be included and transmitted as part of the payload IE of the MAC payload of an RIM for ranging, an RRM, an RFM, an MRM and a ranging result report message (RRRM). The data transfer IE may be transferred as one of a plurality of payload IEs included in the MAC payload of the ranging message. The payload IE of data transfer IE may be configured as shown in Table 1, below. The data transfer IE may distinguish the transferred content according to the data transfer content type, and the data transfer content type may include a payload that refers to general data and may have be a data transfer phase control message (DTPCM) that the controller uses to schedule data transfer.

“Scheduled-based ranging” may be used for the ranging round scheduled by the controller for the controlees to transmit ranging frames (RFRAMEs) and/or measurement reports in different ranging slots. In this disclosure, scheduling-based ranging may be referred to as time-scheduled ranging. A scheduling mode in which scheduling-based ranging is used may be referred to as a time-scheduled mode.

“Contention-based ranging” may be used when the controller does not know the MAC addresses of controlees participating in the UWB session (ranging session). In contention-based ranging, the controller may be an initiator and may perform ranging with other unknown UWB devices. In this disclosure, the scheduling mode in which contention-based ranging is used may be referred to as a contention-based mode.

The contention-based ranging may be used for the ranging round in which the controller determines the size of the contention access period and indicates the contention access period (CAP) size through a ranging control message. In this disclosure, the CAP may be referred to as a contention window or a contention window period.

In the contention-based mode, the UWB device may operate as a controller and an initiator, and in this case, the ranging control phase (RCP) and the ranging initiation phase (RIP) may be merged into the RIP. In the ranging phase (RP), the allocation of the CAP size may determine the CAP period for the responder(s) participating in the corresponding ranging round in units of ranging slots. Each responder may randomly determine one slot in the CAP to transmit an RRM. Messages used in contention-based ranging may use short packet 1 (SP1) as an RFRAME configuration. In contention-based ranging, the RCM transmitted by the controller may be referred to as control message type 2 (CM type 2) or a second ranging control message.

UWB data transfer (or data transfer) is a transmission method in which UWB devices use a ranging round to transfer application data to each other. Data transfer may operate as a data transfer during a ranging mode during ranging in which the data transfer IE is added to the ranging message transmitted in the ranging round allocated for ranging, i.e., two-way ranging or one-way ranging, or may operate in a data transfer phase mode in which the ranging round is independently used only for data transmission separately from ranging. The data transfer phase may also be referred to as data transfer-only phase or data transfer-only.

In the data transfer phase, the controller may perform scheduling for data transfer by transmitting a DPTCM.

Hereinafter, various embodiments of the disclosure are described with reference to the accompanying drawings.

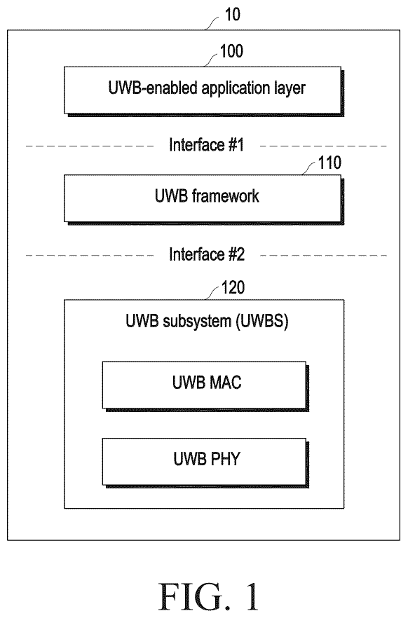

FIG. 1 is an example architecture of a UWB device, according to an embodiment.

Referring to FIG. 1, the UWB device (electronic device) 10 may be a ranging device supporting UWB ranging (e.g., UWB secure ranging). In an embodiment, the ranging device may be an ERDEV defined in the IEEE 802.15 standard or a FiRa device defined by FiRa.

In the embodiment of FIG. 1, the UWB device 10 may interact with other UWB devices through a UWB session.

The UWB device 10 may implement a first interface (Interface #1) that is an interface between the UWB-enabled application 100 and the framework 110, and the first interface allows the UWB-enabled application 100 on the UWB device 10 to use the UWB capabilities of the UWB device 10 in a predetermined manner. In an embodiment, the first interface may be a framework application programming interface (API) or a proprietary interface, but is not limited thereto.

The UWB device 10 may implement a second interface (Interface #2) that is an interface between the Framework 110 and the UWB subsystem (UWBS, 120). In an embodiment, the second interface may be a UWB command interface (UCI) or proprietary interface, but is not limited thereto.

Referring to FIG. 1, the UWB device 10 may include a UWB-enabled application 100, a framework 110, and/or a UWBS 120 including a UWB MAC layer and a UWB physical layer. Depending on the embodiment, some entities may not be included in the UWB device, or additional entities (e.g., security layer) may be further included.

The UWB-enabled application 100 may trigger establishment of a UWB session by UWBS through the first interface. The UWB-enabled application 100 may use one or more previously defined profiles. For example, the UWB-enabled application 100 may use one of the profiles defined in FiRa or a custom profile. The UWB-enabled application 100 may use the first interface to handle related events, such as service discovery, ranging notifications, and/or error conditions.

The UWB framework 110 may provide access to profiles, individual-UWB settings and/or notifications. The UWB Framework 110 may be a set of software components. As described above, the UWB-enabled application 100 may interface with the UWB Framework 110 through the first interface, and the UWB Framework 110 may interface with the UWBS 120 through the second interface.

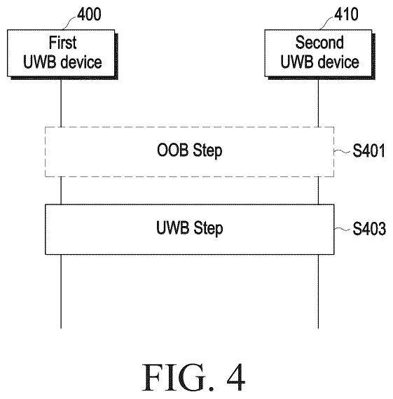

Software components of the UWB Framework 110 may include, e.g., profile manager, OOB connector, secure service, and/or UWB service. The profile manager may serve to manage profiles available on the UWB device. A profile may be a set of parameters required to establish communication between UWB devices. For example, a profile may include a parameter indicating which OOB secure channel is used, a UWB/OOB configuration parameter, a parameter indicating whether the use of a particular secure component is mandatory, and/or a parameter related to the file structure of the ADF. The OOB connector may play a role to establish an OOB connection between UWB devices. The OOB connector may handle an OOB step including a discovery step and a connection step. The OOB step is described below with reference to FIG. 4. The secure service may play a role of interfacing with a secure component, such as SE or TEE. The UWB service may perform a role of managing UWBS. The UWB service may provide access to UWBS from the profile manager by implementing the second interface.

The UWBS 120 may be a hardware component including a UWB MAC layer and a UWB physical layer. The UWBS 120 may perform UWB session management and may communicate with the UWBS of another UWB device. The UWBS 120 may interface with the framework 110 through the second interface and may obtain the RDS from the secure component.

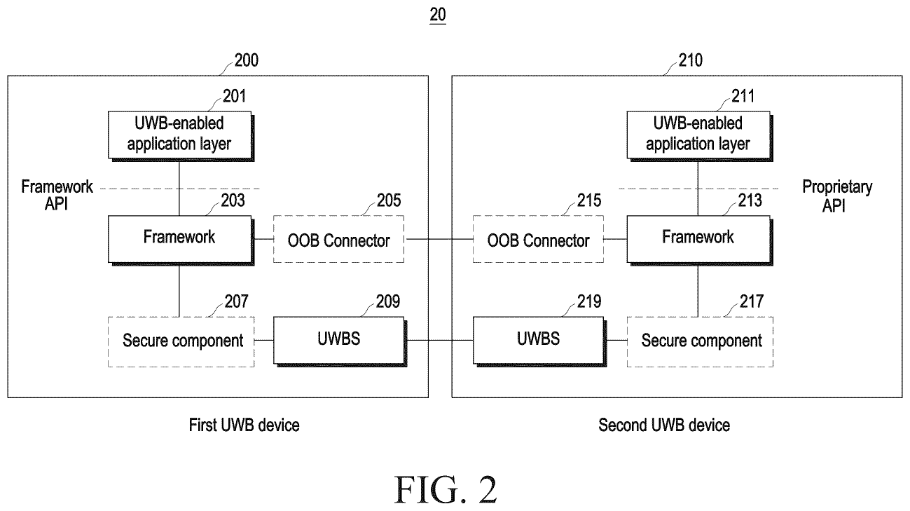

FIG. 2 is an example configuration of a communication system including a UWB device, according to an embodiment.

Referring to FIG. 2, the communication system 20 includes a first UWB device 200 and a second UWB device 210. In an embodiment, the first UWB device 200 and the second UWB device 210 may be, e.g., the UWB device 10 of FIG. 1 or an electronic device including the UWB device 10 of FIG. 1.

The first UWB device 200 may host, e.g., one or more UWB-enabled applications 201, which may be installed by the user (e.g., a mobile phone). It may be based on, e.g., the framework API. The second UWB device 210 may not provide a framework API, and for example, may use a proprietary interface to implement a specific UWB-enabled application 211.

According to an embodiment, both the first UWB device 200 and the second UWB device 210 may be ranging devices using the framework API, or both the first UWB device 200 and the second UWB device 210 may be ranging devices using the proprietary interface.

The first UWB device 200 may include a UWB-enabled application layer 201, a framework 203, an OOB component 205, a secure component 207 and/or a UWBS 209. In the disclosure, the OOB component 205 and/or the secure component 207 may be optional components and, according to an embodiment, may not be included in the first UWB device 200.

The second UWB device 210 may include a UWB-enabled application layer 211, a framework 213, an OOB component 215, a secure component 217, and/or a UWBS 219. In the disclosure, the OOB component 215 and/or the secure component 217 may be optional components and, according to an embodiment, may not be included in the second UWB device 210.

The frameworks 203 and 213 may serve to provide access to profiles, individual-UWB settings, and/or notifications. The frameworks 203 and 213 may be a set of software components, and may include, e.g., profile manager, OOB connector, secure service, and/or UWB service.

The OOB components 205 and 215 may be hardware components including a MAC layer and/or a physical layer for OOB communication (e.g., BLE communication). The OOB components 205 and 215 may communicate with OOB components of other devices. In an embodiment, the first UWB device 200 and the second UWB device 210 may create an OOB connection (channel) using the OOB components 205 and 215 and exchange parameters for establishing a UWB session through the OOB channel. In this disclosure, the OOB components 205 and 215 may be referred to as OOB subsystems.

The UWBS 209 and 219 may be a hardware component including a UWB MAC layer and a UWB physical layer. The UWBS 209 and 219 may perform UWB session management and may communicate with the UWBS of another UWB device. In an embodiment, the first UWB device 200 and the second UWB device 210 may perform transaction of service data and UWB ranging through the UWB session established through the UWBSs 209 and 219 using the exchanged parameters.

The secure components 207 and 217 may be hardware components that interface with the framework and/or UWBS to provide RDS.

In the disclosure, the UWB-enabled application layers 201 and 211 and/or the frameworks 203 and 213 may be implemented by an application processor (AP) (or a processor). Accordingly, in the disclosure, it may be understood that the operations of the UWB-enabled application layers 201 and 211 and/or the frameworks 203 and 213 are performed by an AP (or a processor).

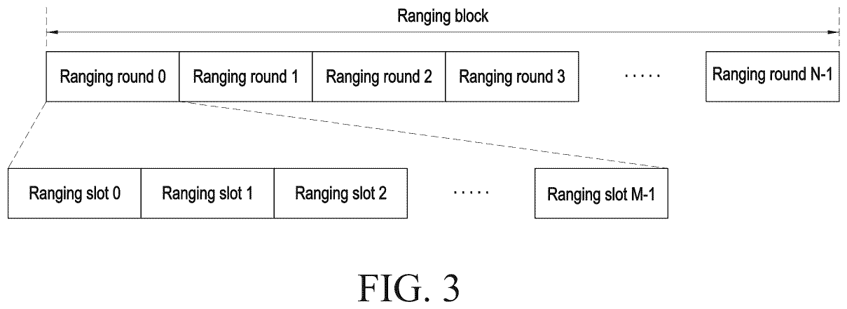

FIG. 3 is a structure of a ranging block and a round used for UWB ranging, according to an embodiment.

In this disclosure, the ranging block refers to a time period for ranging. The ranging round may be a period of sufficient duration to complete one entire range-measurement cycle in which a set of UWB devices participating in a ranging exchange are involved. The ranging slot may be a sufficient period for transmission of at least one RFRAME (e.g., ranging initiation/reply/final message, etc.).

Referring to FIG. 3, one ranging block may include at least one ranging round. Each ranging round may include at least one ranging slot.

When the ranging mode is a block-based mode, a mean time between contiguous ranging rounds may be constant. Alternatively, when the ranging mode is an interval-based mode, the time between contiguous ranging rounds may be dynamically changed. In other words, the interval-based mode may adopt a time structure having an adaptive spacing.

The number and duration of slots included in the ranging round may be changed between ranging rounds. This may be configured through a control message from the controller.

FIG. 4 is a method for performing UWB communication by two UWB devices, according to an embodiment.

Referring to FIG. 4, a first UWB device 400 may play a role as a controller (or controlee), and a second UWB device 410 may play a role as a controlee (or controller), which is the role opposite to the role of the first UWB device 400. The first UWB device 400 may play a role as an initiator (or responder), and the second UWB device 410 may play a role as a responder (or initiator), which is the role opposite to the role of the first UWB device 400.

The first UWB device 400 and the second UWB device 410 may optionally perform an OOB step S401 before the UWB step S403. In this disclosure, the OOB step may be referred to as an OOB connection step.

The OOB step may be a step performed to discover UWB devices through the OOB channel (e.g., BLE channel) and to establish and control a UWB session.

In an embodiment, the OOB step may include at least one of the following steps:
discovering UWB devices and profiles (device and profile discovery),
establishing an OOB connection (channel),
establishing a secure channel to secure messages and data, or
exchanging parameters for establishing a UWB session through the secure channel (e.g., UWB capability parameters (controlee capability parameters), UWB configuration parameters and/or session key-related parameters) (parameter exchange step).

In an embodiment, the parameter exchange step may include the step for the controlee to transfer controlee capability parameters/messages (UWB_CAPABILITY) to the controller, the step for the controller to transfer UWB configuration parameters/messages (UWB_CONFIGURATION) to the controlee, and/or the step for one UWB device to transfer session key-related parameters/messages (SESSION_KEY_INFO) for protecting the UWB session to the other UWB device.

In an embodiment, the controlee (UWB) capability parameter and/or session key parameter may be included and transmitted in the controlee information message (CONTROLLEE_INFO) which is the OOB message transferred from the controlee to the controller. In an embodiment, the UWB configuration parameter and/or session key parameter may be included and transmitted in the session data message (SESSION_DATA) which is the OOB message transferred from the controller to the controlee.

The controlee performance parameter (UWB_CAPABILITY) may include at least one parameter that provides information about the device capability of the controlee. For example, the controller performance parameter may include a parameter for supporting the role of the device (initiator or responder), a parameter for multi-node support, a parameter for supporting STS configuration, a parameter for supporting a ranging method, an RFRAME feature performance parameter, a parameter for supporting angle of arrival (AoA), and/or a parameter for supporting scheduled mode.

The UWB configuration parameter (UWB_CONFIGURATION) may include at least one parameter used for configuration of a UWB session. For example, UWB configuration parameters may include a UWB session ID parameter, a ranging method parameter, a multi-node configuration parameter, an STS configuration parameter, a scheduled mode parameter, a time-of-flight (ToF) report parameter, an AoA-related parameter, a parameter indicating the number of slots per ranging round, a slot duration parameter, a responder slot index parameter, a MAC address mode parameter, a device MAC address parameter, a parameter indicating the number of controlees, and/or a destination (DST) MAC address parameter.

The session key-related parameter (SESSION_KEY_INFO) may include a session key-related parameter for dynamic STS and/or a session key-related parameter for static STS. For example, the session key-related parameter for dynamic STS may include data exchanged to generate a UWB session key or data directly used as a UWB session key. For example, the static STS may include an ID (vendor ID) of a vendor that is a provider of the UWB-enabled application and any pre-defined value (static STS IV) selected by the UWB-enabled application for the UWB device. The vendor ID may be used to set the phyVupper64 parameter for Static STS, and the Static STS IV may be used to set the vUpper64 parameter.

The first UWB device 400 and the second UWB device 410 may perform a UWB step S403. In this disclosure, the UWB step may be referred to as an UWB connection step.

The UWB step may be a step which is performed to perform UWB ranging through the UWB session and transfer service data.

In an embodiment, the UWB step may include at least one of the following steps:
Starting a UWB session (UWB Trigger),
Performing UWB ranging to obtain the distance/position between two UWB devices, or
Exchanging service data (transaction).

As described above, the OOB step is an optional step and may be omitted in some embodiments. For example, when discovery of a UWB device and/or establishment and control of a UWB session are performed through a UWB channel (in-band), the OOB step may be omitted. For example, when in-band discovery is performed, the OOB step of performing OOB discovery may be omitted. In this case, the UWB step may further perform an operation for discovering a UWB device through the UWB channel and exchanging parameters for UWB session configuration.

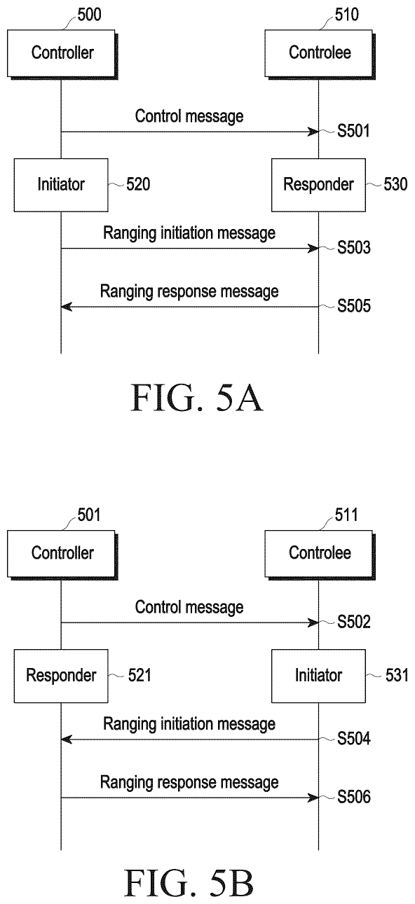

FIGS. 5A and 5B are methods for performing UWB ranging by two UWB devices, according to various embodiments.

FIG. 5A illustrates an embodiment in which the first UWB device operates as the controller 500/initiator 520, and the second UWB device operates as the controlee 510/responder 530. FIG. 5B illustrates an embodiment in which the first UWB device operates as the controller 501/responder 521, and the second UWB device operates as the controlee 511/initiator 531.

Referring to FIGS. 5A and 5B, the controllers 500 and 501 may transmit a control message for UWB ranging to the controlee 510 and 511 in steps S501 and S502, respectively. The ranging control message may be used to carry ranging parameter(s) for controlling and configuring a ranging procedure. In an embodiment, the control message may include information about the role (e.g., initiator or responder) of the ranging device, ranging slot index information, and/or address information about the ranging device.

The initiators 520 and 531 may transmit an RIM for initiating UWB ranging to the responders 530 and 521 in steps S503 and S504, respectively. In an embodiment, the initiators 520 and 531 may transmit an RIM through an SP1 packet or an SP3 packet. When the RIM is transmitted through the SP1 packet, the control message may be included and transmitted in the PHY payload of the RIM. When the RIM is transmitted through the SP3 packet, the RIM does not include the PHR and PHY payloads.

The responders 530 and 521 may transmit an RRM to the initiators 520 and 531 in response to the RIM in steps S505 and S506, respectively. In an embodiment, the responders 530 and 521 may transmit an RRM through an SP1 packet or an SP3 packet. When the ranging reply message is transmitted through the SP1 packet, a first MRM may be included and transmitted in the PHY payload of the ranging reply message. In an embodiment, the first MRM may include an AoA measurement, a reply time measured by the responder and/or a list of round-trip time measurements for responders and responder addresses. The reply time field may indicate a time difference between the reception time of the RIM and the transmission time of the ranging reply message at the responder side. Based on this, single-sided two-way ranging (SS-TWR) may be performed. ToF calculation through SS-TWR follows the scheme defined in IEEE 802.15.4z or FiRa.

In the case of DS-TWR, the initiators 520 and 531 may further transmit an RFM to the responders 530 and 521 to complete the ranging exchange. When the RFM is transmitted through the SP1 packet, a second MRM may be included and transmitted in the PHY payload of the RFM. In an embodiment, the second MRM may include an AoA measurement, the round-trip time for the first responder (first round-trip time) and/or a list of reply time measurements for responders and responder addresses. When the sender of the MRM is the initiator, the first round-trip time field may indicate a time difference between the RIM from the initiator and the first ranging reply message from the first responder. Alternatively, when the sender of the MRM is the responder, the first round-trip time field may indicate a time difference between the ranging reply message from the responder and the RFM from the initiator. Based on this, DS-TWR may be performed. ToF calculation through DS-TWR follows the scheme defined in the IEEE 802.15 standard or FiRa.

According to an embodiment, the above-described first MRM and/or second MRM may not be included in the ranging reply message and/or the RFM but may be transmitted as separate messages. For example, when the non-deferred mode is applied, the MRM may be transmitted through the data frame after the ranging exchange.

The initiators 520 and 531 and the responders 530 and 521 may perform UWB ranging according to a predetermined schedule mode. For example, in the time-scheduled ranging mode, the controller may know the IDs of all controlees and may designate an accurate schedule of ranging transmission. As another example, in the contention-based ranging mode, the controller may not know the number and ID of the controlees, and thus UWB devices compete with each other. In this case, a collision may occur between the responding devices.

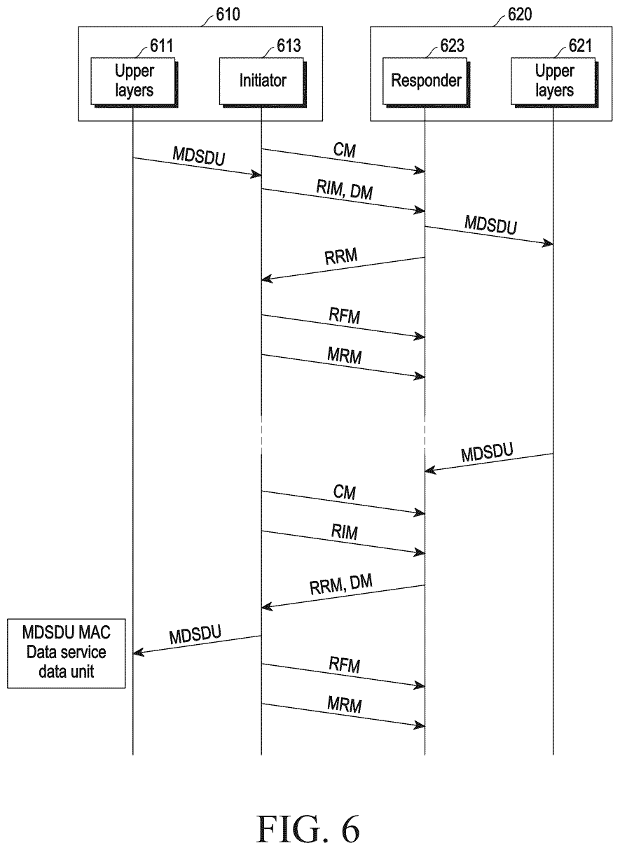

FIG. 6 is an example of one-to-one (1:1) DS-TWR ranging, according to an embodiment.

Referring to FIG. 6, the first UWB device 610 and/or the second UWB device 620 may transmit piggybacked data (or data message) behind the payload of the UWB message according to the FiRa standard. According to an embodiment, the first UWB device 610 and/or the second UWB device 620 may transmit data (or data message) piggybacked on an RIM and/or an RRM in a TWR session (or a TWR phase).

The first UWB device 610 may include an upper layer 611 and an initiator device 613. The first UWB device 620 may include an upper layer 621 and a responder device 623. According to an embodiment, the upper layer 611 may be implemented as the MAC layer of the first UWB device 610, and the upper layer 621 may be implemented as the MAC layer of the first UWB device 620.

The initiator device 613 may transmit a CM (referring to a control message) for one-to-one (1:1) DS-TWR ranging to the responder device 623.

The upper layer 611 may transmit a MAC data service data unit MDSDU to the initiator device 613. According to an embodiment, the MDSDU may be transmitted from the MAC layer to the link layer, or may be transfer from the link layer to the MAC layer. The initiator device 613 may piggyback a DM (referring to a data message) corresponding to the MDSDU and transmit the RIM to the responder device 623. The responder device 623 may transfer an MDSDU corresponding to the DM to the upper layer 621. Thereafter, the responder device 623 may transmit the RRM to the initiator device 613. The initiator device 613 may transmit an RFM and/or an MRM to the responder device 623.

The upper layer 621 may transmit the MDSDU to the responder device 623. The initiator device 613 may transmit CM and RIM for one-to-one (1:1) DS-TWR ranging to the responder device 623. Thereafter, the responder device 623 may piggyback the DM corresponding to the MDSDU and transmit the RRM to the initiator device 613. The initiator device 613 may transfer an MDSDU corresponding to the DM to the upper layer 611. Thereafter, the initiator device 613 may transmit the RFM and/or MRM to the responder device 623.

According to an embodiment, the size (e.g., 175 bytes) of the DM that the initiator device 613 may transmit and receive and the size (e.g., 144 bytes) of the DM that the responder device 623 may transmit and receive may be set (or implemented) differently.

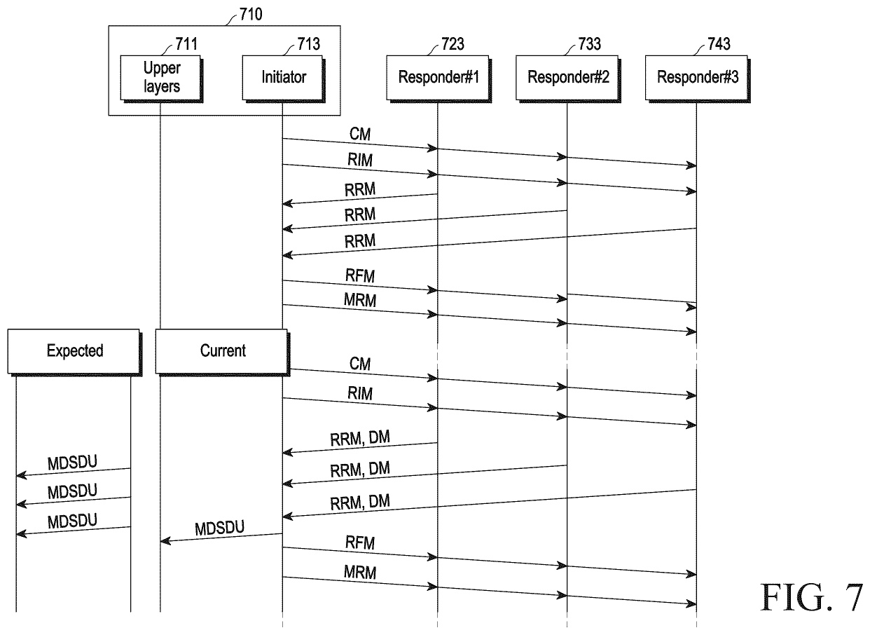

FIG. 7 is an example of one-to-many (1:N) DS-TWR ranging, according to an embodiment.

Referring to FIG. 7, the first UWB device 710 may include an upper layer 711 and an initiator device 713. The initiator device 713 may perform one-to-one (1:N) DS-TWR ranging with a plurality of responder devices 723, 733, and 743.

The initiator device 713 may transmit a CM and a RIM to each of the plurality of responder devices 723, 733, and 743. Each of the plurality of responder devices 723, 733, and 743 may transmit an RRM corresponding to the RIM to the initiator device 713. The initiator device 713 may transmit an RFM and/or an MRM to each of the plurality of responder devices 723, 733, and 743.

According to an embodiment, the initiator device 713 may transmit a CM and a RIM to each of the plurality of responder devices 723, 733, and 743. Each of the plurality of responder devices 723, 733, and 743 may piggyback the DM and transmit the RRM to the initiator device 713. When the plurality of responder devices 723, 733, and 743 transmit multiple DMs to the initiator device 713 at the same time during one-to-one (1:N) DS-TWR ranging, the initiator device 713 may not receive all of the plurality of DMs and may receive at least some DMs as many as the available capacity. For example, the initiator device 713 may receive all of the DMs transmitted by the first responder device 723 and some of the DMs transmitted by the second responder device 733, and may not receive the DM transmitted by the fourth responder device 733. The initiator device 713 may transfer an MDSDU corresponding to the received DMs to the upper layer 711. In other words, even when the plurality of responder devices 723, 733, and 743 transmit a plurality of DMs to the initiator device 713, the initiator device 713 may transfer an MDSDU corresponding to at least some DMs as many as the receiving capability to the upper layer 711. Thereafter, the initiator device 713 may transmit the RFM and/or MRM to the responder device 723.

On the other hand, since the initiator device 713 reports all of the data received from at least one of the plurality of responder devices 723, 733, and 743 once on the UWB command interface, it may be difficult to distinguish the transmission address for each data. In the case of ranging data, a ranging report is reported once, but it may be possible to distinguish the transmission address for each data on an API of an application.

There is a possibility that data may be missing due to limitations on transmission/reception data of the UWB device. For example, if the size of the data transmitted by the first responder device 723 is 84 bytes and the size of the data transmitted by the second responder device 733 is 99 bytes, the reception data capacity (e.g., 175 bytes) of the initiator device 713 may be exceeded (84+99=183>175), and data as much as 8 bytes may be missing.

According to an embodiment, a transaction index for setting the length of payment data in the gate system may be set as shown in Table 1.

TABLE 1

| Transaction index | Length [Bytes] |
|---|---|
| 1 | 61 |
| 2 | 61 |
| 3 | 190 |
| 4 | 71 |
| 5 | 84 |
| 6 | 137 |
| 7 | 65 |
| 8 | 61 |

For example, the transaction index for payment data of the first responder device 723 may be set to 5, and the transaction index of the second responder device 733 may be set to 3.

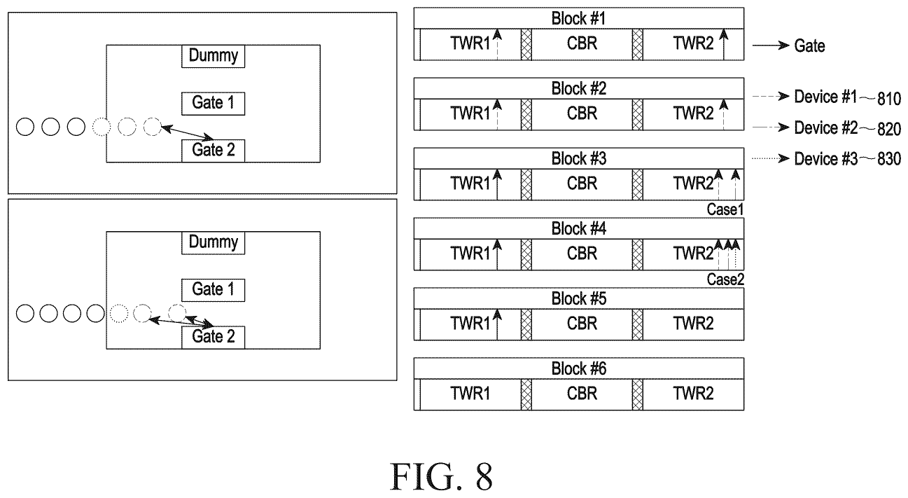

FIG. 8 is an example of transmitting a data message by a UWB device in a gate system, according to an embodiment.

Referring to FIG. 8, a first gate device Gate 1, a second gate device Gate 2, and a dummy gate device each including a UWB communication module may be implemented in the gate system. The first to third devices 810, 820, and 830, respectively, each including the UWB communication module may pass between the first gate device Gate 1 and the second gate device (Gate 2) and perform a payment operation through UWB message exchange with one of the first gate device Gate 1 and the second gate device Gate 2.

In the first TWR phase corresponding to TWR1 in the first ranging block Block #1, the first device 810 may transmit the 1-1th UWB message to the second gate device Gate 2, and in the second TWR phase corresponding to TWR2 in the first ranging block Block #1, the second gate device Gate 2 may transmit the 1-2th UWB message corresponding to the 1-1th UWB message to the first device 810.

In each of the first TWR phase corresponding to TWR1 and the second TWR phase corresponding to TWR2 in the second ranging block Block #2, the first device 810 may transmit second UWB messages to the second gate device Gate 2.

In the first TWR phase corresponding to TWR1 in the third ranging block Block #3, the second gate device Gate 2 may transmit a 3-1th UWB message, in the second TWR phase corresponding to TWR2 in the third ranging block Block #3, the first device 810 may transmit a 3-2th UWB message to the second gate device Gate 2, and the second device 820 may transmit a 3-3th UWB message to the second gate device Gate 2. In this case, the second gate device Gate 2 may not distinguish the transmission address for each of the 3-2th UWB message and the 3-3th UWB message.

In the first TWR phase of the fourth ranging block Block #4, the second gate device Gate 2 may transmit the 4-1th UWB message, and in the second TWR phase of the fourth ranging block Block #4, the first device 810 may transmit the 4-2th UWB message to the second gate device Gate 2, the second device 820 may transmit the 4-3th UWB message to the second gate device Gate 2, and the third device 830 may transmit the 4-4th UWB message to the second gate device Gate 2. In this case, the second gate device Gate 2 may not distinguish the transmission address for each of the 4-2th UWB message to the 4-4th UWB message, and may not receive some of the 4-2th UWB message to the 4-4th UWB message in excess of the reception data capacity.

In the first TWR phase corresponding to TWR1 in the fifth ranging block #5, the second gate device Gate 2 may transmit the fifth UWB message.

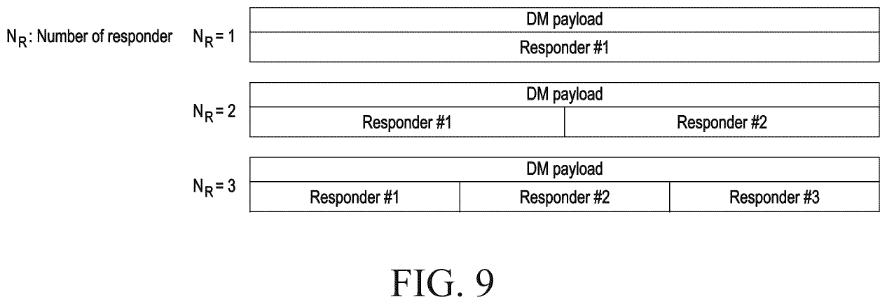

FIG. 9 is a view illustrating examples of payloads in a data message, according to an embodiment of the disclosure.

Referring to FIG. 9, the first UWB device (or initiator device) may receive a data message from at least one UWB device (or at least one responder device).

Data corresponding to the number N_{R} of responder devices may be included in the payload of the data message according to the number N_{R} of responder devices. For example, when N_{R}=1, the payload of the data message may include data (Responder #1) of the first responder device. For example, when N_{R}=2, the payload of the data message may include data Responder #1 of the first responder device and data Responder #2 of the second responder device. For example, when N_{R}=3, the payload of the data message may include data of the first responder device Responder #1, data of the second responder device Responder #2, and data of the third responder device Responder #3.

However, there is a need for a method of adding an address to data (or data message) or distributing limited transmission/reception data in order for the initiator device to determine the number of responder devices connected in the session (phase).

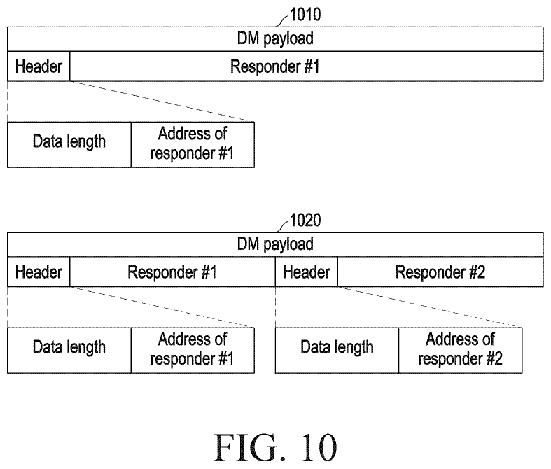

FIG. 10 is a view illustrating examples of headers included in a data message, according to an embodiment.

Referring to FIG. 10, the payload 1010 of the data message may include a header and data Responder #1 of the responder device. The header may include the length (data length) of the data Responder #1 of the responder device and address information (Address of responder #1) of the responder device.

According to an embodiment, the payload 1020 of the data message may include a first header, data Responder #1 of the first responder device, a second header, and data Responder #2 of the second responder device. The first header may include a length (data length) of the data Responder #1 of the first responder device and address information (Address of responder #1) of the first responder device. The second header may include a length (data length) of the data Responder #2 of the second responder device and address information (Address of responder #2) of the second responder device.

Since data coming from the binary UCI may not be distinguished for each address, a transmission address may be included in each of the first header and the second header. Data length may be included in each of the first header and the second header for data segmentation of the initiator device.

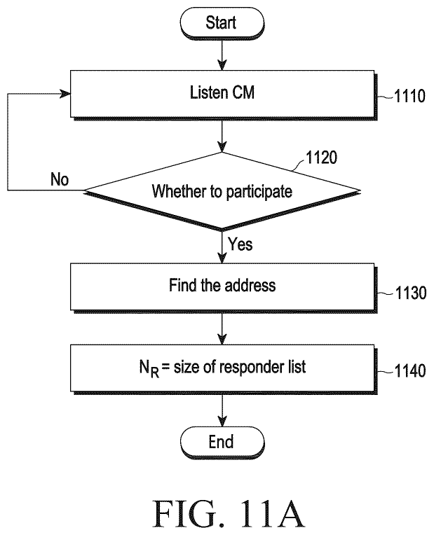

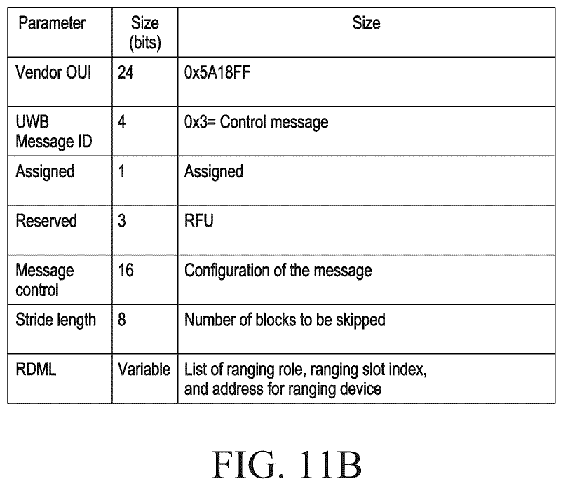

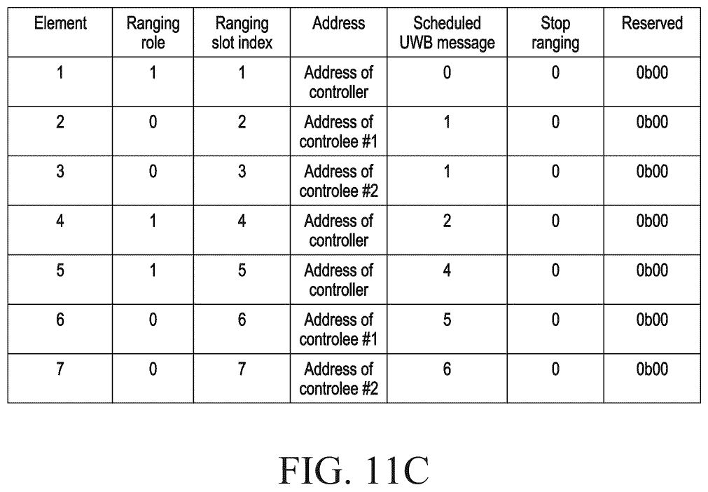

FIG. 11A is an example of a method for determining the number of responders by a UWB device, according to an embodiment.

Referring to FIG. 11A, in step 1110, a first UWB device (or responder device) may receive a control message CM containing an RDML from a second UWB device (or initiator device). The RDML may define a schedule of all initiator devices and responder devices participating in the session (phase).

In step 1120, the first UWB device (or responder device) may determine whether to participate in the session (phase).

When the first UWB device (or responder device) determines to participate in the session (phase)(Yes in step 1120), in step 1130, the first UWB device (or responder device) may identify address information included in the control message CM. In step 1140, the first UWB device (or responder device) may identify the number of responder devices (N_{R}, number of connected responder(s)) connected in the session (phase) in the RDML.

When the first UWB device (or responder device) determines not to participate in the session (No in step 1120), in step 1110, the first UWB device (or responder device) may receive a control message CM including an RDML from the second UWB device (or initiator device).

FIG. 11B is an example of a payload IE content field of a control message, according to an embodiment.

Referring to FIG. 11B, the payload IE of the control message may include a vender organizationally unique identifier (OUI), a UWB message ID, an assigned field, a reserved, a message control, a stride length, and RDML parameters.

The UWB message ID parameter may indicate the type of the corresponding UWB message. For example, if the UWB message ID is 0x0, the corresponding UWB message may be a RIM; if the UWB message ID is 0x1, the corresponding UWB message may be a RRM; if the UWB message ID is 0x2, the corresponding UWB message may be a RFM; if the UWB message ID is 0x3, the corresponding UWB message may be a control message CM; if the UWB message ID is 0x4, the corresponding UWB message may be a MRM; if the UWB message ID is 0x5, the corresponding UWB message may be a ranging result report message; if the UWB message ID is 0x6, the corresponding UWB message may be a control update message; if the UWB message ID is 0x7, the corresponding UWB message may be a one way ranging message; and if the UWB message ID is 0x8, the corresponding UWB message may be a data message.

The message control parameter may include a configuration of a corresponding message, and the stride length parameter may indicate the number of blocks (or ranging blocks) to be skipped.

The RDML parameter may include at least one of a list of ranging roles, a ranging slot index, and an address for ranging device.

FIG. 11C is an example of an RDML used during a DS-TWR, according to an embodiment.

Referring to FIG. 11C, the RDML may include an element, a ranging role, a ranging slot index, an address, a scheduled UWB message, a stop ranging field, and a reserved. The RDML may indicate the ranging role, the ranging slot index, and the address of each UWB device.

For example, when element=1, the ranging role may be set to 1, the ranging slot index may be set to 1, the address may be set to the controller's address, the scheduled UWB message may be set to 0, the stop ranging may be set to 0, and the reserved may be set to 0b00. For example, when element=2, the ranging role may be set to 0, the ranging slot index may be set to 2, the address may be set to the address of controlee #1, the scheduled UWB message may be set to 1, the stop ranging may be set to 0, and the reserved may be set to 0b00.

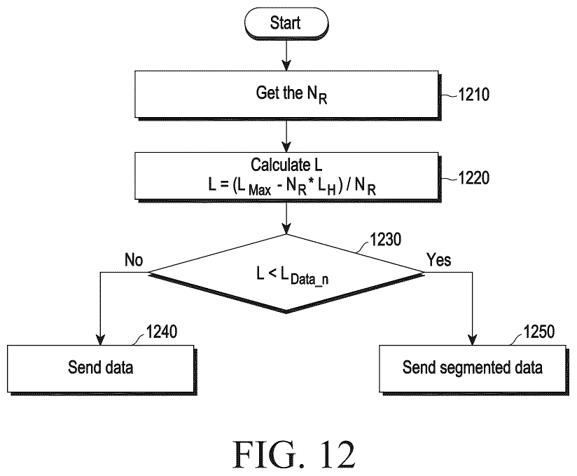

FIG. 12 is an example of a method for determining whether to transmit data or segmented data by a UWB device, according to an embodiment.

Referring to FIG. 12, in step 1210, the UWB device (or responder device) may identify the number of responder devices (N_{R}, number of connected responder(s)) connected in the corresponding session (phase) from the RDML included in the control message CM.

In step 1220, the UWB device (or responder device) may calculate the maximum data size (L_{Max}, max data length) that the UWB device (or responder device) may transmit. According to an embodiment, the UWB device (or responder device) may calculate the maximum data size L that may be transmitted based on Equation 1.

$$L = ( {L}_{Max} - {N}_{R} * {L}_{H} ) / {N}_{R} \qquad Equation 1$$

Here, L_{Max} may indicate the maximum (Max) data length in the corresponding session (phase), and L_{H} may indicate the header size (e.g., 4 bytes) of the transaction message (or data message). For example, L_{H} may be composed of the sum of the size (e.g., two bytes) of the data length and the size (e.g., two bytes) of the address of responder.

In step 1230, the UWB device (or responder device) may determine whether the maximum data size L that may be transmitted is less than the length (L_{Data_n}) of the nth transaction data (or data).

If the maximum data size L is not less than the length (L_{Data_n}) of the nth transaction data (or data) (No in step 1230), in step 1240, the UWB device (or responder device) may transmit (unsegmented) data.

If the maximum data size L is less than the length (L_{Data_n}) of the nth transaction data (or data) (Yes in step 1230), in step 1250, the UWB device (or responder device) may transmit segmented data.

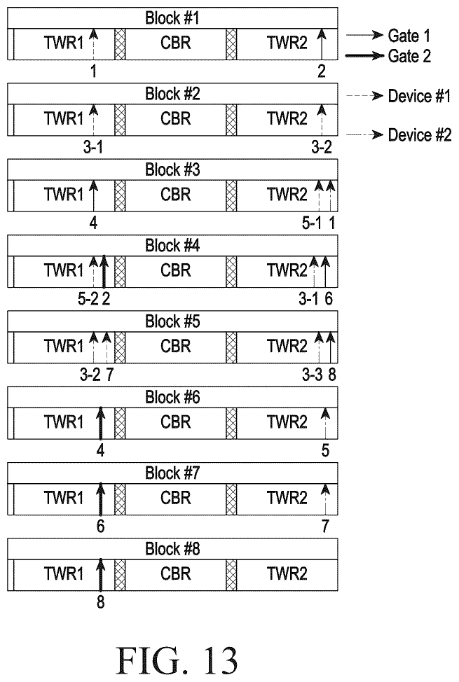

FIG. 13 is an example of a method for configuring a phase in a ranging block in a gate system, according to an embodiment.

Referring to FIG. 13, the gate system may include a first gate device Gate 1, a second gate device Gate 2, a first device Device #1, and a second device Device #2 each including a UWB communication module. Each of the first device Device #1 and the second device Device #2 may pass between the first gate device Gate 1 and the second gate device Gate 2 while performing a payment operation through UWB message exchange with at least one of the first gate device Gate 1 and the second gate device Gate 2. According to an embodiment, a transaction index for setting the length of payment data in the gate system may be set as shown in Table 1.

For example, the transaction index for payment data of the first responder device may be set to 5, and the transaction index of the second responder device may be set to 3.

For example, if N_{R}=2,

$$L = \frac{175 - 2 * 4}{2} = 83 ,$$

and the transaction index is set to 3 (190 bytes), the first device Device #1 or the second device Device #2 may segment the data—previously segmented into 99 bytes and 91 bytes—into three segments of 80 bytes, 80 bytes, and 30 bytes by reflecting L, and may transmit the data.

For example, if N_{R}=2,

$$L = \frac{175 - 2 * 4}{2} = 83 ,$$

and the transaction index is set to 5 84 bytes, the first device Device #1 or the second device Device #2 may segment the data into 44 bytes and 40 bytes and transmit the same.

FIG. 13 illustrates a payment process in which devices exchange eight UWB messages for payment in a gate system (tagless gate). Although FIG. 13 illustrates eight UWB messages for payment for convenience of description, the technical spirit of the disclosure is not limited thereto, and the number of UWB messages may be implemented as various numbers. In FIG. 13, the first UWB message is represented by “1” and the nth UWB message is represented by “n” (where n is a natural number and satisfies 2≤n≤8). The nth UWB message may be segmented and displayed as an n-1th UWB message, an n−2th UWB message, an n-3th UWB message, or the like.

In the first TWR phase corresponding to TWR1 in the first ranging block Block #1, the first device Device #1 may transmit a first UWB message to the first gate device Gate 1, and in the second TWR phase corresponding to TWR2 in the first ranging block Block #1, the first gate device Gate 1 may transmit a second UWB message corresponding to the first UWB message to the first device Device #1.

In each of the first TWR phase corresponding to TWR1 and the second TWR phase corresponding to TWR2 in the second ranging block Block #2, the first device #1 may transmit a 3-1th UWB message and a 3-2th UWB message, respectively.

In the first TWR phase corresponding to TWR1 in the third ranging block Block #3, the first gate device Gate 1 may transmit a fourth UWB message, in the second TWR phase corresponding to TWR2 in the third ranging block Block #3, the first device Device #1 may transmit a 5-1th UWB message, and the second device Device #2 may transmit a first UWB message.

In the first TWR phase corresponding to TWR1 in the fourth ranging block Block #4, the first device Device #1 may transmit a 5-2th UWB message, and the first gate device Gate 1 may transmit a second UWB message. In the second TWR phase corresponding to TWR2 in the fourth ranging block Block #4, the second device Device #2 may transmit a 3-1th UWB message, and the first gate device Gate 1 may transmit a sixth UWB message.

In the first TWR phase corresponding to TWR1 in the fifth ranging block #5, the second device #2 may transmit a 3-2th UWB message, and the first device #1 may transmit a seventh UWB message. In the second TWR phase corresponding to TWR2 in the fifth ranging block #5, the second device #2 may transmit a 3-3th UWB message, and the first gate device Gate 1 may transmit an eighth UWB message.

The second gate device Gate 2 may transmit a fourth UWB message in the first TWR phase corresponding to TWR1 in the sixth ranging block Block #6, and the second device Device #2 may transmit a fifth UWB message in the second TWR phase corresponding to TWR2 in the sixth ranging block Block #6.

The second gate device Gate 2 may transmit a sixth UWB message in the first TWR phase corresponding to TWR1 in the seventh ranging block Block #7, and the second device Device #2 may transmit a seventh UWB message in the second TWR phase corresponding to TWR2 in the seventh ranging block Block #7.

In the first TWR phase corresponding to TWR1 in the eighth ranging block #8, the second gate device Gate 2 may transmit an eighth UWB message.

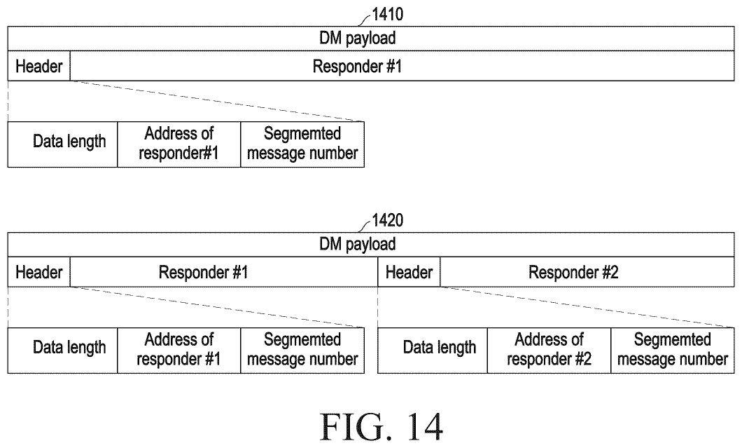

FIG. 14 is a view illustrating examples of headers included in a data message, according to an embodiment.

Referring to FIG. 14, the payload 1410 of the data message may include a header and data Responder #1 of the first responder device. The header may include a length (data length) of the data Responder #1 of the first responder device, address information (address of responder #1) of the first responder device, and a segmented message number for the data of Responder #1 of the first responder device. According to an embodiment, the header in the payload 1410 may include address information (Address of responder #1) of the first responder device to distinguish data coming from the binary phase UCI of the UWB device for each address. According to an embodiment, the header in the payload 1410 may include data length for data segmentation of the received message. According to an embodiment, for data segmentation of the transmission message, the header in the payload 1410 may include a segmented message number.

The payload 1420 of the data message may include a first header, data Responder #1 of the first responder device, a second header, and data Responder #2 of the second responder device. The first header may include a length (data length) of the data Responder #1 of the first responder device, address information (Address of responder #1) of the first responder device, and a segmented message number for the data Responder #1 of the first responder device. The second header may include a length (data length) of the data Responder #2 of the second responder device, address information (Address of responder #2) of the second responder device, and a segmented message number for the data Responder #2 of the second responder device.

In the disclosure, for convenience of description, it is illustrated that the payload 1410 includes data Responder #1 of the first responder device, and the payload 1420 includes data Responder #1 of the first responder device and data Responder #2 of the second responder device, however the technical spirit of the disclosure is not limited thereto. According to an embodiment, the payload 1410 and/or the payload 1420 may include data of three or more responder devices.

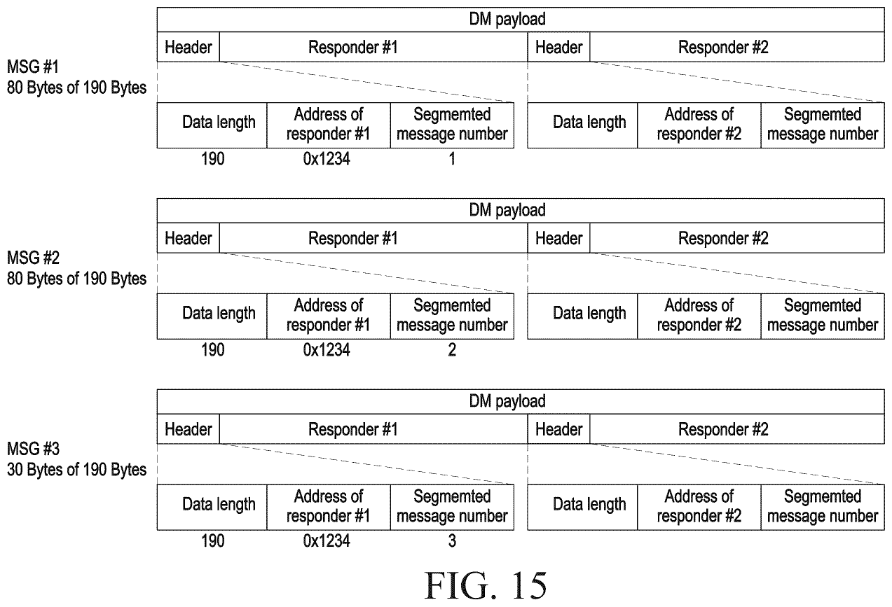

FIG. 15 is a view illustrating examples of headers included in a data message, according to an embodiment.

Referring to FIG. 15, the configuration of the payload in the data message is illustrated in which the maximum data size (L) that the first responder device may transmit is 83 bytes and the total data length L_{Data,3} that the first responder device intends to transmit is 190 bytes.

When the total length (L_{Data,3}) of data to be transmitted by the first responder device is 190 bytes, the first responder device may allocate 80 bytes to the first data message, 80 bytes to the second data message, and 30 bytes to the third data message.

The header for the first data message may include the data length (e.g., 190 bytes), address information (Address of responder #1) (e.g., 0x1234) of the first responder device, and the segmented message number (e.g., 1) of segmented data transmitted by the first responder device.

The header for the second data message may include the data length (e.g., 190 bytes) of data transmitted by the first responder device, address information (Address of responder #1) (e.g., 0x1234) of the first responder device, and the segmented message number (e.g., 2) of segmented data transmitted by the first responder device.

The header for the first data message may include the data length (e.g., 190 bytes), address information (Address of responder #1) (e.g., 0x1234) of the first responder device, and the segmented message number (e.g., 3) of segmented data transmitted by the first responder device.

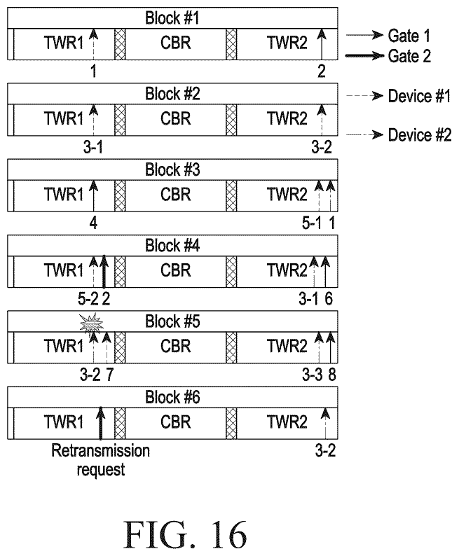

FIG. 16 is an example of a method for configuring a phase in a ranging block in a gate system, according to an embodiment.

Referring to FIG. 16, the gate system may include a first gate device Gate 1, a second gate device Gate 2, a first device Device #1, and a second device Device #2 each including a UWB communication module. Each of the first device Device #1 and the second device Device #2 may pass between the first gate device Gate 1 and the second gate device Gate 2 while performing a payment operation through UWB message exchange with at least one of the first gate device Gate 1 and the second gate device Gate 2.

FIG. 16 illustrates a payment process in which devices exchange eight UWB messages for payment in a gate system (tagless gate). Although FIG. 16 illustrates eight UWB messages for payment for convenience of description, the technical spirit of the disclosure is not limited thereto, and the number of UWB messages may be implemented as various numbers.

FIG. 16 illustrates an example in which, when a specific device fails to successfully receive a segmented message (e.g., the 3-2th UWB message), a message retransmission for the segmented message is requested.

In the first TWR phase corresponding to TWR1 in the first ranging block Block #1, the first device Device #1 may transmit a first UWB message to the first gate device Gate 1, and in the second TWR phase corresponding to TWR2 in the first ranging block Block #1, the first gate device Gate 1 may transmit a second UWB message corresponding to the first UWB message to the first device Device #1.

In each of the first TWR phase corresponding to TWR1 and the second TWR phase corresponding to TWR2 in the second ranging block Block #2, the first device #1 may transmit a 3-1th UWB message and a 3-2th UWB message, respectively.

In the first TWR phase corresponding to TWR1 in the third ranging block Block #3, the first gate device Gate 1 may transmit a fourth UWB message, in the second TWR phase corresponding to TWR2 in the third ranging block Block #3, the first device Device #1 may transmit a 5-1th UWB message, and the second device Device #2 may transmit a first UWB message.

In the first TWR phase corresponding to TWR1 in the fourth ranging block Block #4, the first device Device #1 may transmit a 5-2th UWB message, and the first gate device Gate 1 may transmit a second UWB message. In the second TWR phase corresponding to TWR2 in the fourth ranging block Block #4, the second device Device #2 may transmit a 3-1th UWB message, and the first gate device Gate 1 may transmit a sixth UWB message.

In the first TWR phase corresponding to TWR1 in the fifth ranging block #5, the second device #2 may transmit a 3-2th UWB message, and the first device #1 may transmit a seventh UWB message. In the second TWR phase corresponding to TWR2 in the fifth ranging block #5, the second device #2 may transmit a 3-3th UWB message, and the first gate device Gate 1 may transmit an eighth UWB message.

If the 3-2th UWB message is not successfully received, the second gate device Gate 2 may transmit a message (Retransmission request) for requesting retransmission of the 3-2th UWB message to the second device Device #2 in the first TWR phase corresponding to TWR1 of the sixth ranging block Block #6. In the second TWR phase corresponding to TWR2 in the sixth ranging block Block #6, the second device Device #2 may retransmit the requested 3-2th UWB message.

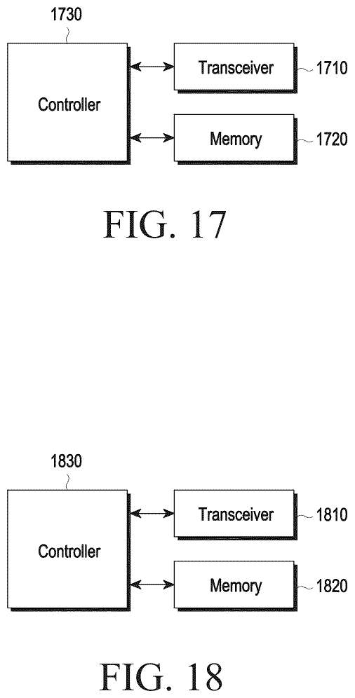

FIG. 17 illustrates a structure of a first UWB device, according to an embodiment.

Each of the UWB device, the first UWB device, the first device, and/or the initiator with reference to FIGS. 1 to 16 may correspond to the first UWB device of FIG. 17.

Referring to FIG. 17, the first UWB device may include a transceiver 1710, memory 1720, and a controller 1730.

The transceiver 1710, controller 1730, and memory 1720 of the UWB device may be operated according to the above-described UWB device communication method. However, the components of the UWB device are not limited thereto. For example, the UWB device may include more or fewer components than the above-described components. The transceiver 1710, the controller 1730, and the memory 1720 may be implemented in the form of a single chip. According to an embodiment, the controller 1730 may include at least one processor. According to an embodiment, the controller 1730 may include at least one host.

The transceiver 1710 collectively refers to a transmitter of the first UWB device and a receiver of the first UWB device and may transmit and receive signals to/from another device. To that end, the transceiver 1710 may include an radio frequency (RF) transmitter for frequency-up converting and amplifying signals transmitted and an RF receiver for low-noise amplifying signals received and frequency-down converting the frequency of the received signals. However, this is merely an example of the transceiver 1710, and the components of the transceiver 1710 are not limited to the RF transmitter and the RF receiver. According to an embodiment, the transceiver 1710 may include a UWBS (e.g., the UWBS 120 of FIG. 1).

The transceiver 1710 may receive signals via a radio channel, output the signals to the controller 1730, and transmit signals output from the controller 1730 via a radio channel.

The memory 1720 may store programs and data necessary for the operation of the first UWB device. Further, the memory 1720 may store control information or data that is included in the signal obtained by the first UWB device. The memory 1720 may include a storage medium, such as a read-only memory (ROM), random access memory (RAM), hard disk, compact disc-ROM (CD-ROM), and digital versatile disc (DVD), or a combination of storage media. Rather than being separately provided, the memory 1720 may be embedded in the controller 1730.

The controller 1730 may control a series of processes for the first UWB device to be able to operate according to the above-described embodiments of the disclosure.

According to an embodiment, the controller 1730 may control transmission of a control message including an RDML for UWB ranging, which controls transmission of an RIM based on the control message, and receive, from a second UWB device, an RRM corresponding to the RIM and data piggybacked on the RRM. According to an embodiment, the data may include a header and a payload, and wherein the header includes a length of the data and an address of the second UWB device.

According to an embodiment, the RDML may include at least one of a list of ranging roles, a ranging slot index, and an address for each ranging device.

According to an embodiment, the controller 1730 may receive segmented data from the second UWB device if a maximum data size L that the second UWB device may transmit is less than a length L_{Data_n} of nth data.

According to an embodiment, the maximum data size L that the second UWB device may transmit may be calculated based on a number N_{R} of responder devices connected in a phase, a maximum data length L_{Max} in the phase, and a header size L_{H} of the data message. According to an embodiment, the number N_{R} of responder devices connected in the phase may be determined based on the RDML included in the control message.

FIG. 18 is a structure of a second UWB device, according to an embodiment.

Each of the UWB device, the second UWB device, the second device, and/or the responder described with reference to FIGS. 1 to 16 may correspond to the second UWB device of FIG. 18.

Referring to FIG. 18, the second UWB device may include a transceiver 1810, memory 1820, and a controller 1830.

The transceiver 1810, controller 1830, and memory 1820 of the UWB device may be operated according to the above-described UWB device communication method. However, the components of the UWB device are not limited thereto. For example, the UWB device may include more or fewer components than the above-described components. The transceiver 1810, the controller 1830, and the memory 1820 may be implemented in the form of a single chip. According to an embodiment, the controller 1830 may include at least one processor. According to an embodiment, the controller 1830 may include at least one host.

The transceiver 1810 collectively refers to a transmitter of the UWB device and a receiver of the UWB device and may transmit and receive signals to/from another device. To that end, the transceiver 1810 may include an RF transmitter for frequency-up converting and amplifying signals transmitted and an RF receiver for low-noise amplifying signals received and frequency-down converting the frequency of the received signals. However, this is merely an embodiment of the transceiver 1810, and the components of the transceiver 1810 are not limited to the RF transmitter and the RF receiver. The transceiver 1810 may include a UWBS (e.g., the UWBS 120 of FIG. 1).

The transceiver 1810 may receive signals via a radio channel, output the signals to the controller 1830, and transmit signals output from the controller 1830 via a radio channel.

The memory 1820 may store programs and data necessary for the operation of the UWB device. The memory 1820 may store control information or data that is included in the signal obtained by the UWB device. The memory 1820 may include a storage medium, such as ROM, RAM, hard disk, CD-ROM, and DVD, or a combination of storage media. Rather than being separately provided, the memory 1820 may be embedded in the controller 1830.

The controller 1830 may control a series of processes for the UWB device to be able to operate according to the above-described embodiments.

According to an embodiment, the controller 1830 may receive, from a first UWB device, a control message including an RDML for UWB ranging, receive, from the first UWB device, an RIM based on the control message, and control to transmit, to the first UWB device, an RRM corresponding to the RIM and data piggybacked on the RRM. The data may include a header and a payload, and wherein the header includes a length of the data and an address of the second UWB device.

The methods according to the embodiments descried in the specification or claims of the disclosure may be implemented in hardware, software, or a combination of hardware and software.

When implemented in software, there may be provided a computer readable storage medium storing one or more programs (software modules). One or more programs stored in the computer readable storage medium are configured to be executed by one or more processors in an electronic device. One or more programs include instructions that enable the electronic device to execute methods according to the embodiments described in the specification or claims of the disclosure.

The programs (software modules or software) may be stored in random access memories, non-volatile memories including flash memories, ROMs, electrically erasable programmable read-only memories (EEPROMs), magnetic disc storage devices, CD-ROMs, DVDs, or other types of optical storage devices, or magnetic cassettes. Or, the programs may be stored in memory constituted of a combination of all or some thereof. As each constituting memory, multiple ones may be included.

The programs may be stored in attachable storage devices that may be accessed via a communication network, such as the Internet, Intranet, a local area network (LAN), a WLAN, a storage area network (SAN), or a communication network configured of a combination thereof. The storage device may connect to the device that performs embodiments of the disclosure via an external port. A separate storage device over the communication network may be connected to the device that performs embodiments of the disclosure.

In the above-described specific embodiments of the disclosure, the components included in the disclosure are represented in singular or plural forms depending on specific embodiments proposed. However, the singular or plural forms are selected to be adequate for contexts suggested for ease of description, and the disclosure is not limited to singular or plural components. As used herein, the singular forms “a,” “an,” and “the” are intended to include the plural forms as well, unless the context clearly indicates otherwise.

While the present disclosure has been particularly shown and described with reference to certain embodiments thereof, it will be understood by those of ordinary skill in the art that various changes in form and details may be made therein without departing from the spirit and scope of the disclosure as defined by the appended claims and their equivalents.

What is claimed is:

1. A method of a first ultra-wideband (UWB) device in a wireless communication system, the method comprising:
transmitting a control message including a ranging device management list (RDML) for UWB ranging;
transmitting a ranging initiation message based on the control message; and
receiving, from a second UWB device, a ranging response message corresponding to the ranging initiation message and data piggybacked on the ranging response message,
wherein the data includes a header and a payload, and
wherein the header includes a length of the data and an address of the second UWB device.

2. The method of claim 1, wherein the RDML includes at least one of a list of ranging roles, a ranging slot index, or an address for each ranging device in a group comprised of one or more ranging devices.

3. The method of claim 1, further comprising receiving segmented data from the second UWB device based on a maximum data size (L) that the second UWB device transmits being less than a length (L_{Data_n}) of nth data.

4. The method of claim 3, wherein the maximum data size (L) that the second UWB device transmits is calculated based on a number (N_{R}) of responder devices connected in a phase, a maximum data length (L_{Max}) in the phase, and a header size (L_{H}) of the data message.

5. The method of claim 4, wherein the number (N_{R}) of responder devices connected in the phase is determined based on the RDML included in the control message.

6. A method of a second ultra-wide band (UWB) device in a wireless communication system, the method comprising:
receiving, from a first UWB device, a control message including a ranging device management list (RDML) for UWB ranging;
receiving, from the first UWB device, a ranging initiation message based on the control message; and
transmitting, to the first UWB device, a ranging response message corresponding to the ranging initiation message and data piggybacked on the ranging response message,
wherein the data includes a header and a payload, and
wherein the header includes a length of the data and an address of the second UWB device.

7. The method of claim 6, wherein the RDML includes at least one of a list of ranging roles, a ranging slot index, or an address for each ranging device in a group comprised of one or more ranging devices.

8. The method of claim 6, further comprising transmitting, to the first UWB device, segmented data based on a maximum data size (L) that the second UWB device transmits being less than a length (L_{Data_n}) of nth data.

9. The method of claim 8, wherein the maximum data size (L) that the second UWB device transmits is calculated based on a number (N_{R}) of responder devices connected in a phase, a maximum data length (L_{Max}) in the phase, and a header size L_{H} of the data message.

10. The method of claim 9, wherein the number (N_{R}) of responder devices connected in the phase is determined based on the RDML included in the control message.

11. A first ultra-wideband (UWB) device in a wireless communication system, comprising:
a transceiver; and
a processor coupled with the transceiver and configured to:
control to transmit a control message including a ranging device management list (RDML) for UWB ranging;
control to transmit a ranging initiation message based on the control message; and
receive, from a second UWB device, a ranging response message corresponding to the ranging initiation message and data piggybacked on the ranging response message,
wherein the data includes a header and a payload, and
wherein the header includes a length of the data and an address of the second UWB device.

12. The first UWB device of claim 11, wherein the RDML includes at least one of a list of ranging roles, a ranging slot index, or an address for each ranging device in a group comprised of one or more ranging devices.

13. The first UWB device of claim 11, wherein the processor is configured to receive segmented data from the second UWB device based on a maximum data size (L) that the second UWB device transmits being less than a length (L_{Data_n}) of nth data.

14. The first UWB device of claim 13, wherein the maximum data size (L) that the second UWB device transmits is calculated based on a number (N_{R}) of responder devices connected in a phase, a maximum data length (L_{Max}) in the phase, and a header size (L_{H}) of the data message.

15. The first UWB device of claim 14, wherein the number (N_{R}) of responder devices connected in the phase is determined based on the RDML included in the control message.

16. A second ultra-wideband (UWB) device in a wireless communication system, comprising:
a transceiver; and
a processor coupled with the transceiver and configured to:
receive, from a first UWB device, a control message including a ranging device management list (RDML) for UWB ranging;
receive, from the first UWB device, a ranging initiation message based on the control message; and
control to transmit, to the first UWB device, a ranging response message corresponding to the ranging initiation message and data piggybacked on the ranging response message,
wherein the data includes a header and a payload, and
wherein the header includes a length of the data and an address of the second UWB device.

17. The second UWB device of claim 16, wherein the RDML includes at least one of a list of ranging roles, a ranging slot index, or an address for each ranging device in a group comprised of one or more ranging devices.

18. The second UWB device of claim 16, wherein the processor is configured to control to transmit, to the first UWB device, segmented data based on a maximum data size (L) that the second UWB device transmits being less than a length (L_{Data_n}) of nth data.

19. The second UWB device of claim 18, wherein the maximum data size (L) that the second UWB device transmits is calculated based on a number (N_{R}) of responder devices connected in a phase, a maximum data length (L_{Max}) in the phase, and a header size (L_{H}) of the data message.

20. The second UWB device of claim 19, wherein the number (N_{R}) of responder devices connected in the phase is determined based on the RDML included in the control message.
